(19) United States
(12) Patent Application Publication
(10) Pub. No.: US 2012/0051093 A1
(43) Pub. Date: Mar. 1, 2012

(54) Light Guide with Embedded Light Sources

(75) Inventors: Udayan Kanade, Pune (IN); Dimple Kuriakose, Pune (IN); Ruby Rama Praveen, Pune (IN); Sanat Ganu, Pune (IN)

(73) Assignee: I2IC CORPORATION, Foster City, CA (US)

(21) Appl. No.: 13/319,095

(22) PCT Filed: May 6, 2010
(86) PCT No.: PCT/US10/33938

§ 371 Date: Nov. 7, 2011

(30) Foreign Application Priority Data
May 6, 2009 (IN) 1194/MUM/2009

(51) Int. Cl. F21V 8/00

(52) U.S. Cl. 362/629

(57) ABSTRACT

A light guide system is disclosed in which one or more light sources are embedded within the body of the light guide. The light sources emit light into the light guide. Light entering the light sources from outside is either reflected back or is allowed to pass through. In an embodiment, a light guide with light deflecting particles within it is used. The concentration of the light deflecting particles within the light guide can be varied based on the location of the embedded light sources in order to obtain a desired light emanation pattern. In an embodiment, external light sources can be used to increase the amount of light and mirrors can be used to reduce wastage and increase the amount of light. Finally, by building the light guide system in a modular form, multiple light guide modules can be combined to get a light source of desired specifications.

This application claims priority from provisional patent application number 1194/MUM/2009 titled “Light Guide with Embedded Light Sources” filed on 6 Mar. 2009 at Mumbai, India.

### FIELD OF THE INVENTION

The present invention relates to a light guide system. More particularly, the invention relates to a light guide with embedded light sources within it.

### BACKGROUND

Light guides that guide light from light sources placed close to them are well known in the art. The light traveling through the light guide maybe deflected out of the light guide through various means such as light deflecting particles within the light guide, surface relief structures on the inner walls of the light guide etc. The amount of light that gets deflected out of the light guide depends not only on the light deflecting means used, but also on the distance traveled by the light within the light guide.

### SUMMARY

A light guide system is disclosed in which one or more light sources are embedded within the body of the light guide. The light sources emit light into the light guide. Light entering the light sources from outside is either reflected back or is allowed to pass through. In an embodiment, a light guide with light deflecting particles within it is used. The concentration of the light deflecting particles within the light guide can be varied based on the location of the embedded light sources in order to obtain a desired light emanation pattern. In an embodiment, external light sources can be used to increase the amount of light and mirrors can be used to reduce wastage and increase the amount of light. Finally, by building the light guide system in a modular form, multiple light guide modules can be combined to get a light source of desired specifications.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiments and together with the general description given above and the detailed description of the preferred embodiments given below serve to explain and teach the principles of the present invention.

FIG. 1 illustrates a block diagram of an exemplary light guide with embedded light source system, according to one embodiment.

FIG. 2 illustrates a block diagram of an exemplary light guide system that has both embedded and external light sources, according to one embodiment.

FIG. 3 illustrates a block diagram of an exemplary light guide system that has both embedded and external light sources, according to one embodiment.

FIG. 4 illustrates a block diagram of an exemplary light guide system that has reflective mirrors along with an embedded light source, according to one embodiment.

FIG. 5 illustrates a block diagram of an exemplary light guide system that has reflective mirrors along with an embedded light source, according to one embodiment.

FIG. 6 illustrates a block diagram of an exemplary light guide system that has reflective mirrors along with an embedded light source, according to one embodiment.

FIG. 7 illustrates a block diagram of an exemplary light guide system, with multiple embedded light sources, according to one embodiment.

FIG. 8 illustrates a block diagram of an exemplary light guide system, with multiple embedded light sources, according to one embodiment.

FIG. 9 illustrates a block diagram of an exemplary light guide system, with multiple embedded light sources, according to one embodiment.

FIG. 10 illustrates a block diagram of an exemplary light source system, that has light deflecting surface relief structures and an embedded light source within it, according to one embodiment.

FIG. 11 illustrates a block diagram of an exemplary light source system, according to one embodiment.

FIG. 12 illustrates a block diagram of an exemplary light source system, according to one embodiment.

FIG. 13 illustrates a block diagram of an exemplary light source system, according to one embodiment.

FIG. 14 illustrates a block diagram of an exemplary light source system, according to one embodiment.

FIG. 15 illustrates a block diagram of an exemplary light source system, according to one embodiment.

FIG. 16 illustrates a block diagram of an exemplary light source system, according to one embodiment.

FIG. 17 illustrates a block diagram of an exemplary light source system, according to one embodiment.

FIG. 18 illustrates a block diagram of an exemplary light source system, according to one embodiment.

FIG. 19 illustrates a block diagram of an exemplary point light source, according to one embodiment.

FIG. 20 illustrates a block diagram of an exemplary point light source, according to one embodiment.

FIG. 21 illustrates a block diagram of an exemplary point light source, according to one embodiment.

FIG. 22 illustrates a block diagram of an exemplary point light source, according to one embodiment.

FIG. 23 illustrates a block diagram of an exemplary point light source, according to one embodiment.

FIG. 24 is a ray diagram of a reflective point light source, according to one embodiment.

FIG. 25 is a ray diagram of a transmissive point light source, according to one embodiment.

FIG. 26 is a ray diagram of a point light source, according to one embodiment.

FIG. 27 is a ray diagram of a point light source, according to one embodiment.

FIG. 28 is a ray diagram of a light source system, according to one embodiment.

FIG. 29 is a ray diagram of a light source system, according to one embodiment.

FIG. 30 is a ray diagram of a light source system, according to one embodiment.

FIG. 31 illustrates a light source system according to an embodiment.

FIG. 32 illustrates the side view of a light source system, according to an embodiment.

FIG. 33 illustrates the bottom view of a light source system, according to an embodiment.

FIG. 34 illustrates a light source system, according to one embodiment.

FIG. 35 illustrates a light source system, according to one embodiment.

FIG. 36 illustrates a modular light source system, according to one embodiment.

### DETAILED DESCRIPTION

A light guide system is disclosed in which one or more light sources are embedded within the body of the light guide. The light sources emit light into the light guide. Light entering the light sources from outside is either reflected back or is allowed to pass through. In an embodiment, a light guide with light deflecting particles within it is used. The concentration of the light deflecting particles within the light guide can be varied based on the location of the embedded light sources in order to obtain a desired light emanation pattern. In an embodiment, external light sources can be used to increase the amount of light and mirrors can be used to reduce wastage and increase the amount of light. Finally, by building the light guide system in a modular form, multiple light guide modules can be combined to get a light source of desired specifications.

### GLOSSARY OF TERMS

A reflector is any means of reflecting light. Specular light reflectors or mirrors include metallic surfaces, distributed Bragg reflectors, hybrid reflectors, total internal reflectors or omni-directional reflectors. Diffuse light reflectors include paints, suspensions of transparent materials, dyes, etc.
A point light source is a light source emitting light from a small region. E.g. an LED (Light Emitting Diode), a LASER (Light Amplification by Stimulated Emission of Radiation) or a filament can act as a point light source. A small linear or surface light source (described below) can also be considered to be a point light source when viewed from afar, or when emitting light into a much larger body.
A linear light source is a light source emitting light from a region which has one large dimension. A linear light source could be shaped like a tube with circular, square or other cross section, for example. A linear light source could be shaped like a prism having a particular cross section (polygonal or curved, curvilinear, etc.) E.g. a bank of LEDs, a fluorescent tube, a gas discharge tube, an incandescent filament.
A surface light source is a light source emitting light from a region which has two large dimensions. A surface light source will have at least one large light emitting surface. It may have a small thickness, i.e. it may be in the form of a sheet.
A light guide is an object which guides light within it. A light guide may comprise a transparent material of a refractive index larger than the refractive index of a surrounding material, and will guide light by total internal reflection. A light guide may also comprise a reflective cavity, and will guide light by reflection. A light guide may be augmented by features such as light deflectors which deflect the light out of the light guide, so that the light guide acts as a light source. The light guide may be placed in a reflecting cavity so that the light is emanated preferentially in certain directions. The reflectors may be placed close to the surface of the light guide, with a small gap of air, or vacuum or lower refractive index material to facilitate total internal reflection at the surface of the light guide. Alternatively, the reflectors of the reflecting cavity may be optically bonded to the surface of the light guide. The reflector may be deposited directly on the surface of the light guide.
A light deflector is an element that deflects light traveling within a light guide. A light deflector may be a small transparent particle or bubble, which deflects light incident on it by refraction, reflection at the boundary, by diffusion inside the particle, by scattering, or by total internal reflection. A light deflector may be a transparent particle with a different refractive index than the surrounding medium. A light deflector may be a spherical or an aspherical particle. Light deflectors may be aspherical particles embedded in a specific orientation with respect to the light guide. Light deflectors may change the wavelength of light. For example a light deflector may contain photoluminescent material. A light deflector may be a surface relief structure. Light deflectors may be irregularities or small white dots or geometric shapes, such as prisms or lenses.
A linear light guide is a light guide with one large dimension.
A sheet light guide is a light guide with two large dimensions.

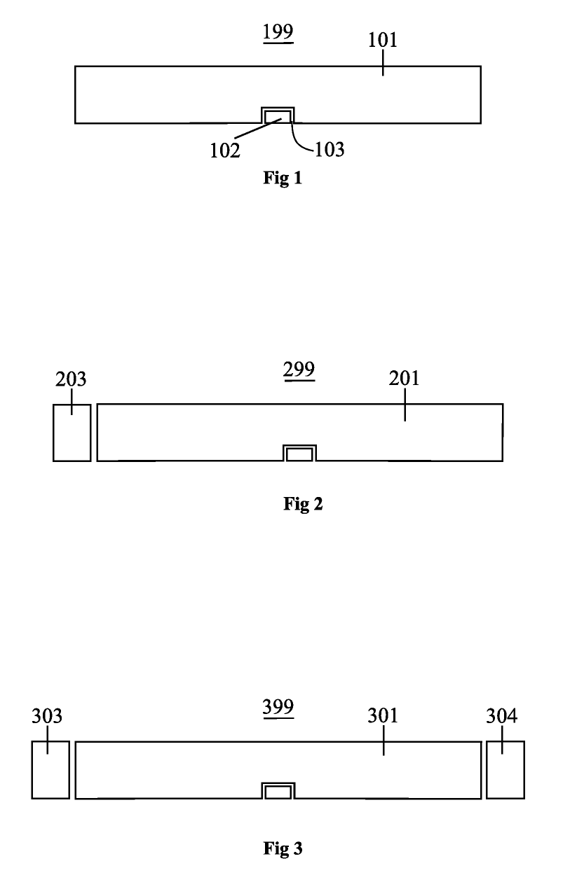

FIG. 1 illustrates a block diagram of an exemplary light guide with embedded light source system 199, according to one embodiment. Light source 102 is embedded within a light guide 101. Light emitted from the light source 102 is coupled into the light guide 101 and then travels through it. The light source 102 may be a point light source or a linear light source. The light guide 101 may be a linear light guide or a surface light guide.

In an embodiment, light emitted from the light source 102 is coupled into the light guide 101 such that all or primarily all light from the light source 102 will get coupled into a direction that is guided along the light guide, i.e. into a direction that totally internally reflects at the guiding boundary of the light guide. This may be achieved by keeping an air gap (or a gap of a lower refractive index material) 103, between the light source and the light guide, so that light rays entering the light guide refract in such a way that the guiding effect is achieved. Furthermore, to facilitate this guiding effect, the interface from which light enters the light guide may be chosen to be perpendicular or approximately perpendicular to the guiding boundary or boundaries of the light guide. Even when coupled in such a way, the light being guided may eventually exit the light guide due to deflection by a light deflecting feature such as a light deflecting particle.

In an embodiment, the light source 102 is not present at an end of the light guide 101, i.e. the light source 102 is present at a location from which the light guide 101 extends to at least two opposing sides of the light guide 101. The light source 102 may emit light such that it travels to both these sides, or such that it travels to one of these sides.

In an embodiment, the light source 102 is embedded within the body of the light guide 101 in a recess in the body of the light guide 101 such that the said recess has the same shape as the light source embedded within it.

FIG. 2 illustrates a block diagram of an exemplary light guide system 299 that has both embedded and external light sources, according to one embodiment. Point light source 203 is placed close to one end of the linear light guide 201. The presence of point light source 203 outside the linear light guide 201 adds to the total amount of light that is sent into the linear light guide 201. I.e. light from both the point sources, one embedded within the light guide and one placed outside, enter the light guide 201 and travel through it. Similarly, point or linear light sources may be placed outside a surface light guide, such that their light is coupled into the light guide.

FIG. 3 illustrates a block diagram of an exemplary light guide system 399 that has both embedded and external light sources, according to one embodiment. Point light sources 303 and 304 are placed close to two opposite ends of a linear light guide 301. This allows light from both ends to enter into the light guide 301, thereby resulting in a more uniform distribution of light within the light guide 301. Similarly, point or linear light sources may be placed outside a surface light guide, on two opposite or all four ends, in such a way that their light is coupled into the light guide.

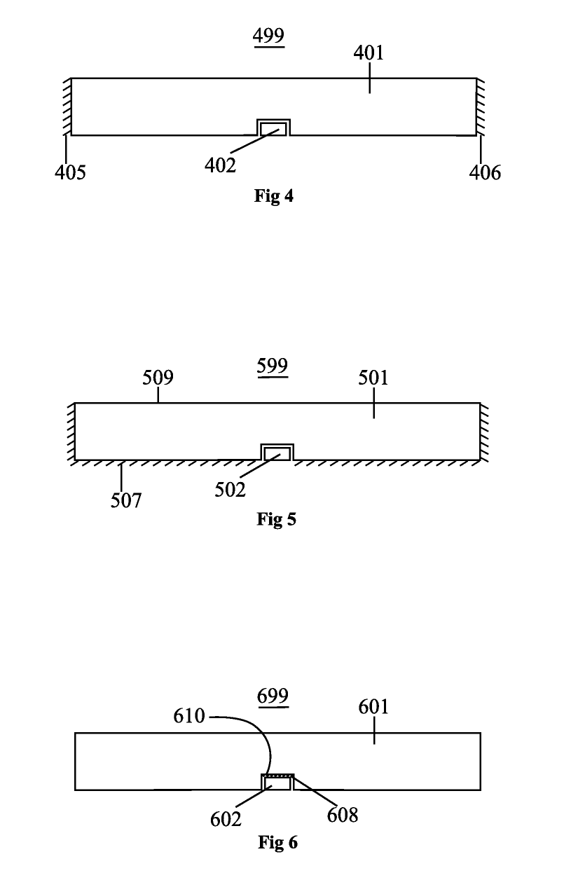

FIG. 4 illustrates a block diagram of an exemplary light guide system 499 that has reflective mirrors along with an embedded light source, according to one embodiment. The two ends of a linear light guide 401 are made reflective using mirrors 405 and 406. This allows the reutilization of the light reaching the ends of the linear light guide 401. Light from the light source 402 embedded within the light guide 401 may travel all the way to the ends of the light guide 401 and then go out, if there are no mirrors such as 405 and 406. Similarly, ends of a surface light guide may be made reflective.

FIG. 5 illustrates a block diagram of an exemplary light guide system 599 that has reflective mirrors along with an embedded light source, according to one embodiment. Linear light guide 501 is made reflective on a surface opposite to the light emitting surface 509. This is done using the mirror 507, which may be placed adjacent to, or optically coupled to, or deposited onto the said surface. Light from the light source 502 travels through the light guide 501 and may exit the light emitting surface 509 due to various reasons such as deflections, scattering etc. Some of the light may also travel in the opposite direction and reach the mirror 507, which will then reflect it back into the direction of the light emitting surface. The mirror 507 may be optically coupled to the light guide 501, or kept separate, with an air gap or low refractive index material between them. Similar to the above, a surface opposite to a light emitting surface of a surface light guide may be made transparent.

In an embodiment, the light source 502 is embedded into the surface opposite to the light emitting surface 509. The light source 502 may be embedded into the surface next to which the mirror 507 is placed. The mirror 507 may or may not cover the embedded light source 502 itself. In the case that it does, this will prevent loss of light towards the non-emanating side of the light guide. In the case that it does not, an internal reflector of the light source 502 may also block the light from traveling towards the non-emanating side of the light guide.

FIG. 6 illustrates a block diagram of an exemplary light guide system 699 that has reflective mirrors along with an embedded light source, according to one embodiment. Point light source 602 is embedded within the linear light guide 601. The edge 610 of the linear light guide 601, that covers the point light source 602 is made reflective using the mirror 608. Light from the light source 602 travels throughout the linear light guide 601. Some of this light might travel towards the edge 610. Mirror 608 reflects this light back into the light guide 601. Also, the mirror 608 (or another mirror, facing the light source 602) may prevent light from the light source 602 to enter the edge 610 of the linear light guide. This helps maximum light from the light source 602 to enter through a surface such that the light will be guided through the light guide.

Similar to the above, a mirror may be used between a surface light guide and a linear light guide embedded in it.

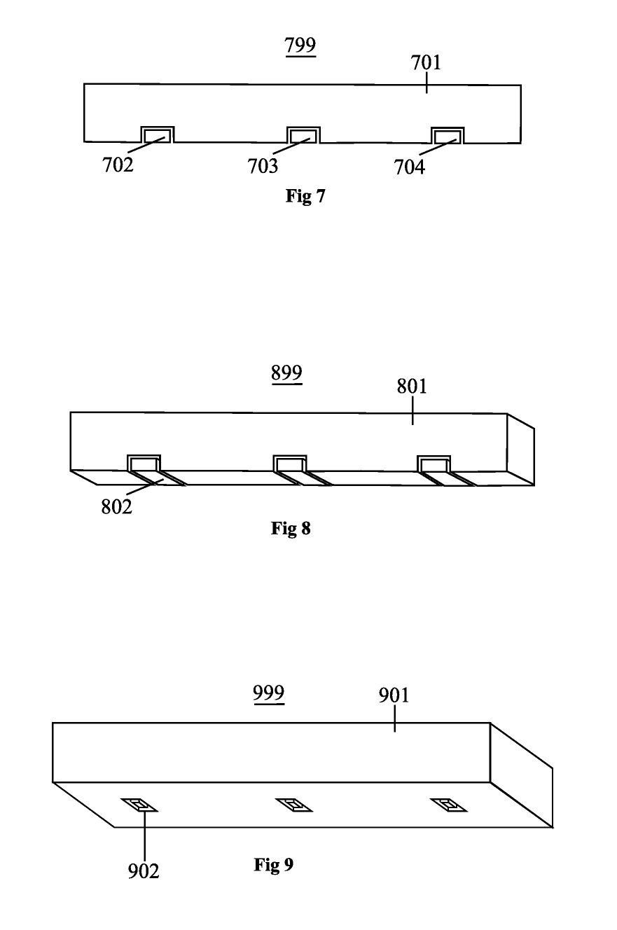

FIG. 7 illustrates a block diagram of an exemplary light guide system 799, with multiple embedded light sources, according to one embodiment. Linear light guide 701 has multiple point light sources such as 702, 703 and 704 embedded within it. The presence of multiple point light sources within the light guide allows more light to be available within the light guide. Thus, a light source of more intensity, or a light source that is larger in its light emitting surface without being thicker or bulkier can be made. Similarly, a surface light source may have multiple embedded linear or point light sources.

FIG. 8 illustrates a block diagram of an exemplary light guide system 899, with multiple embedded light sources, according to one embodiment. In this embodiment, the light sources such as 802 have a dimension that covers the entire width of the light guide 801.

FIG. 9 illustrates a block diagram of an exemplary light guide system 999, with multiple embedded light sources, according to one embodiment. In this embodiment point light sources such as 902 are embedded at different locations within the width of the light guide 901.

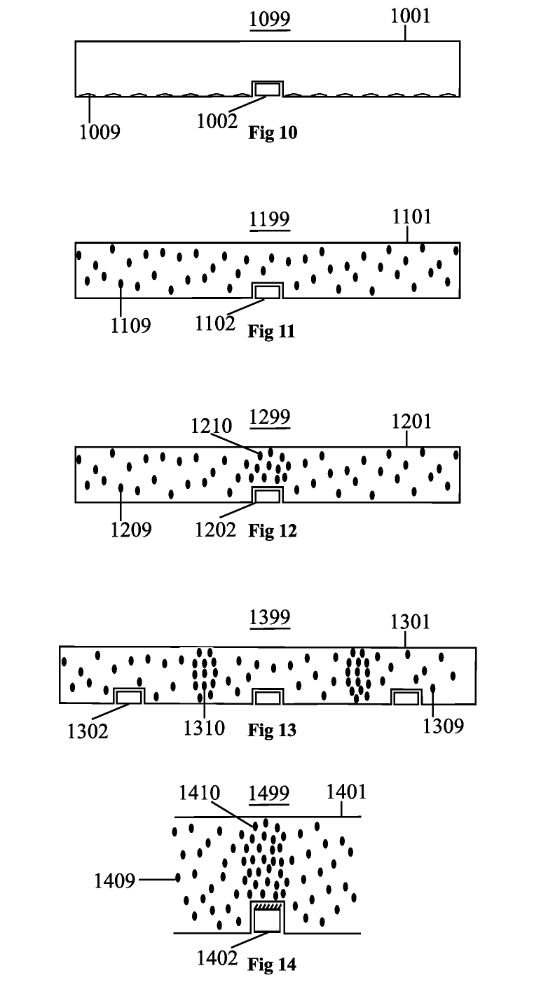

FIG. 10 illustrates a block diagram of an exemplary light source system 1099, that has light deflecting surface relief structures and an embedded light source within it, according to one embodiment. Light deflecting surface relief structures 1009 which may be geometric shapes, etching or dye deposition, deflect part of the light of the light source 1002 traveling within light guide 1001 out of the light guide 1001.

FIG. 11 illustrates a block diagram of an exemplary light source system 1199, according to one embodiment. Light deflecting particles 1109 which deflect light using refraction, reflection or scattering, deflect part of the light of the light source 1102 traveling within light guide 1101 out of the light guide 1101. Light deflecting particles 1109 may also change the wavelength of light, e.g. by photoluminescence.

FIG. 12 illustrates a block diagram of an exemplary light source system 1299, according to one embodiment. Light deflecting particles 1209 are present within a light guide 1201. Light deflecting particles 1209 are present in a larger concentration in a region 1210 above the light source 1202. Since the effective thickness of the light deflecting light guide reduces above the light source 1202 (due to the presence of the light source 1202 within the light guide), the concentration of light deflecting particles 1209 is increased in that region to compensate, so as to avoid a drop in illumination from the area above the light source 1202.

FIG. 13 illustrates a block diagram of an exemplary light source system 1399, according to one embodiment. Light deflecting particles 1309 are present in the light guide 1301 at a higher concentration in a region 1310 away from the light sources (such as light source 1302) compared to in regions near the light sources. This ensures more uniformity of light emanating from light source system 1399.

FIG. 14 illustrates a block diagram of an exemplary light source system 1499, according to one embodiment. Light deflecting particles 1409 are present at a higher concentration in an area 1410 of the light guide 1401 above the light source 1402. A mirror is disposed above the light source 1402, so that direct light from the light source 1402 is not emanated from the light source system 1499.

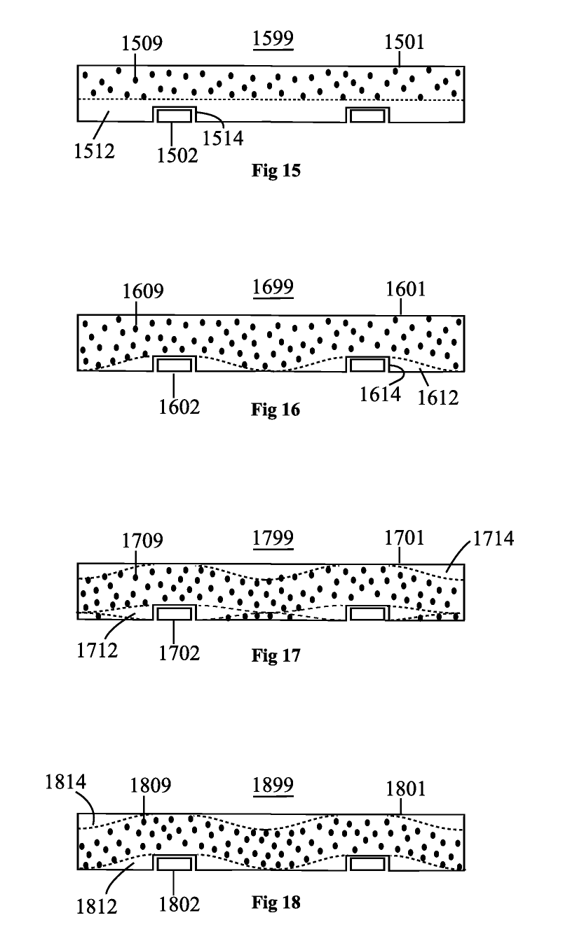

FIG. 15 illustrates a block diagram of an exemplary light source system 1599, according to one embodiment. Light deflecting particles 1509 are not present, or are present in a lower concentration in the slice 1512 of the light guide 1501 that has the embedded light sources such as light source 1502. Since a high concentration of light deflecting particles 1509 is not present very close to the opening 1514 from which light from the light source 1502 enters the light guide 1501, there will be continuity of light emission intensity from the light source system 1599, at the border of the light source 1502. The light deflecting particles are present in a slice of the light guide further away from the light sources. The light deflecting particles may be available in a uniform concentration, or in a varying concentration, e.g. in a higher concentration away from the light sources, and in a lower concentration closer to the light sources.

FIG. 16 illustrates a block diagram of an exemplary light source system 1699, according to one embodiment. Light deflecting particles 1609 are not present, or present in a lower concentration in a region 1612 near the opening 1614 from which light from the light source 1602 enters the light guide 1601. The region 1612 tapers in a direction away from the light source 1602.

FIG. 17 illustrates a block diagram of an exemplary light source system 1799, according to one embodiment. Light deflecting particles 1709 are not present, or present in a lower concentration in a region 1712 near the opening from which light from the light source 1702 enters the light guide 1701. The region 1712 may taper away from the light source 1702 with tapering from above, or below or both. Furthermore, another region such as region 1714 with a different concentration (lower, higher or none) of light deflecting particles 1709 may be present in another part of the light guide 1701. This is so that the average concentration at any location along the light guide is a required concentration such that uniformity of emitted light, or light emitted according to a required emission pattern is achieved. For example, region 1714 may be present near the surface opposite to the surface in which the light sources are embedded, and may be thicker away from the light sources, and thinner near the light sources.

FIG. 18 illustrates a block diagram of an exemplary light source system 1899, according to one embodiment. Light deflecting particles 1809 are not present, or are present in a lower concentration in a region 1812 near the opening from which light from the light source 1802 enters the light guide 1801. The region 1812 tapers away from the light source 1802, tapering from above. Another region, such as region 1814 with a different concentration of light deflecting particles may be present.

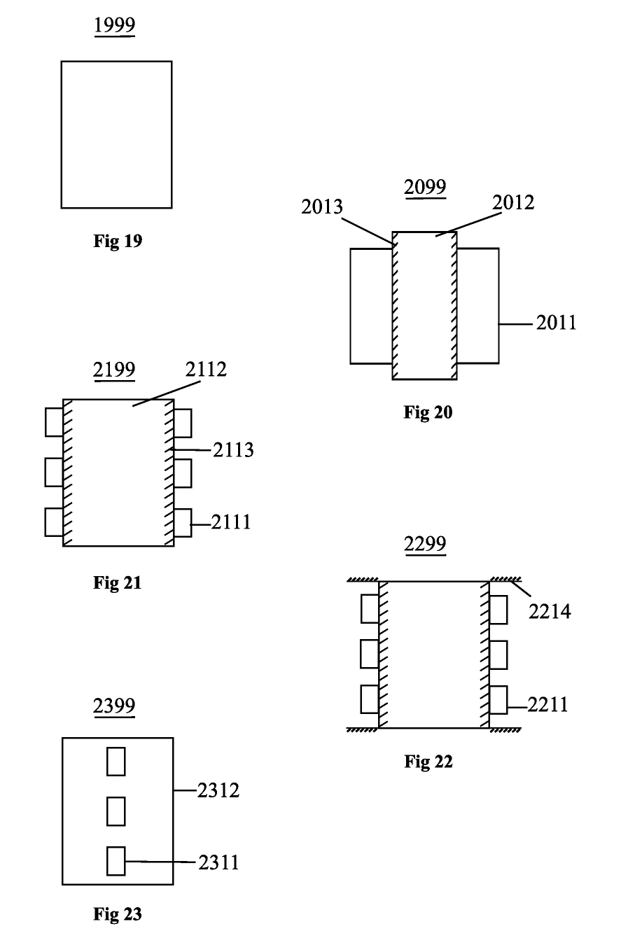

FIG. 19 illustrates a block diagram of an exemplary point light source 1999, according to one embodiment. A point light source 1999 emits light towards the opening in the surface of a light guide (not shown). The light source 1999 may itself be partially or completely transparent or partially or completely reflective to light entering it from outside.

FIG. 20 illustrates a block diagram of an exemplary point light source 2099, according to one embodiment. A point light source 2099 comprises a block 2012 having mirrored surfaces 2013, and one or more light sources 2011 such as light emitting diodes (LEDs), etc. The light sources 2011 may be pointing in different directions, i.e. they may emanate light travelling in mutually opposite directions. Thus, one of the light sources 2011 may emanate light that travels in a particular group of directions in the light guide, and the other of the light sources 2011 may emanate light that travels in an opposing group of directions.

The block 2012 may also act as one or both conductors providing electrical connection to the light sources 2011. Electrical connections may also be provided by wires, e.g. through the use of wire bonding, or by transparent electrodes such as Indium Tin Oxide.

FIG. 21 illustrates a block diagram of an exemplary point light source 2199, according to one embodiment. A point light source 2199 comprises a block 2112 having mirrored surfaces 2113, and a plurality of light sources 2111. The plurality of light sources may all emit the same spectrum of light, or different light sources may emit light of different spectra. For example, some sources may emit blue light, others green and yet others red light. A composition of red green and blue light is useful in display backlights. The amount of red, green and blue may be changed to change the color of the emanating light. The plurality of light sources 2111 may comprise two groups of light sources sourcing light in two opposing groups of directions.

FIG. 22 illustrates a block diagram of an exemplary point light source 2299, according to one embodiment. Mirrors 2214 surrounding the cavity in which the light sources 2211 are placed help guide the light from the light sources 2211 to the opening in the light guide. The mirrors 2214 also help to send the light exiting the light guide back into the light guide.

FIG. 23 illustrates a block diagram of an exemplary point light source 2399, according to one embodiment. Point light source 2399 comprises a transparent block 2312 having one or more light sources 2311, of the same or different spectra. Electrical connections to the light sources 2311 may be made by wires or conductors, or the transparent block 2312 may be a conducting substrate such as Indium Tin Oxide or Silicon Carbide. Substrates such as Gallium Nitride, or various transparent conducting oxides may also be used.

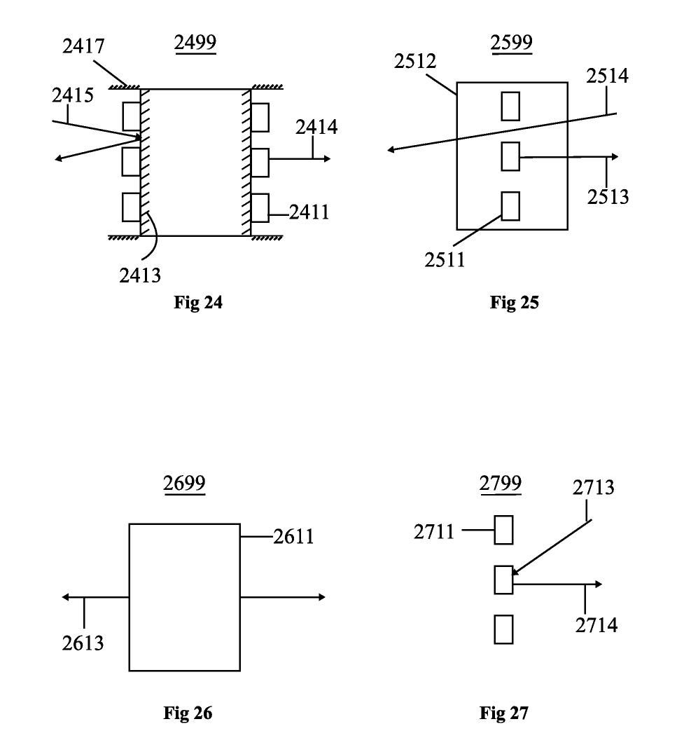

FIG. 24 is a ray diagram of a reflective point light source 2499, according to one embodiment. Exemplary light ray 2414 is emitted by a light source from the one or more light sources 2411. Exemplary light ray 2415 has exited the opening of a light guide (not shown) and is progressing towards the point light source 2499. It bounces off the mirrored surfaces 2413 and possibly off the mirrors 2417 to return to the light guide, thus increasing the efficiency of utilization of light.

FIG. 25 is a ray diagram of a transmissive point light source 2599, according to one embodiment. Exemplary light ray 2513 is emitted by a light source from the one or more light sources 2511. Exemplary light ray 2514 has exited the opening of a light guide. It passes through the transparent block 2512 to another opening of the light guide.

FIG. 26 is a ray diagram of a point light source 2699, according to one embodiment. Light source 2611, which may be a light source such as an LED, emits light 2613. If light exits a light guide towards the point light source, part of it is reflected back due to inherent reflectance, interface reflection, back reflectors, phosphor coatings, diffuser coatings, or the electroluminescent material of an LED, which can also be photoluminescent.

FIG. 27 is a ray diagram of a point light source 2799, according to one embodiment. Light 2713 exits a light guide towards the point light source 2799 and hits one of the light sources 2711. If a light of a lower wavelength meets a light source of a higher wavelength, it may pass through it, or get reflected by a back reflector inside. If a light of a higher wavelength meets a light source of a lower wavelength, it may pass through it or get reflected, or it may get converted to light of the lower wavelength, and get emitted towards the light guide as light 2714.

FIG. 28 is a ray diagram of a light source system 2899, according to one embodiment. Light from embedded light source 2802 is guided within light guide 2801. It may hit a scattering particle such as particle 2809 and get scattered out of the light guide 2801 to give illumination light such as light 2812, or it may continue being guided within the light guide such as light 2811, or light 2813. Such scattered light may be scattered again, and may get scattered out of the light guide 2801 after multiple such scatterings, to give illumination light such as light 2814.

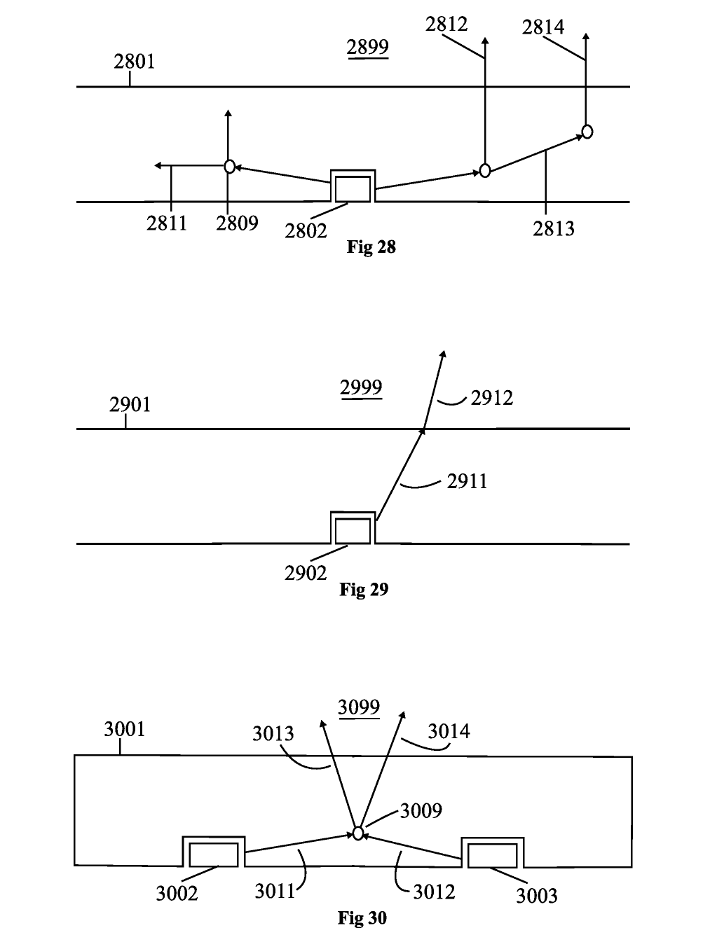

FIG. 29 is a ray diagram of a light source system 2999, according to one embodiment. Light 2911 from the light source 2902 directly exits the light guide 2901 to form illumination light 2912. If the light entry and exit surfaces of the light guide 2901 are polished and perpendicular to each other, and the refractive index is greater than or equal to a minimum refractive index, then such direct emission of light is minimized, or there is no such emission.

FIG. 30 is a ray diagram of a light source system 3099, according to one embodiment. A light deflecting particle 3009 deflects light 3011 from a light source 3002 into a direction 3014 and light 3012 from light source 3003 into a direction 3013. Thus, a single light deflecting particle deflects light from many different light sources.

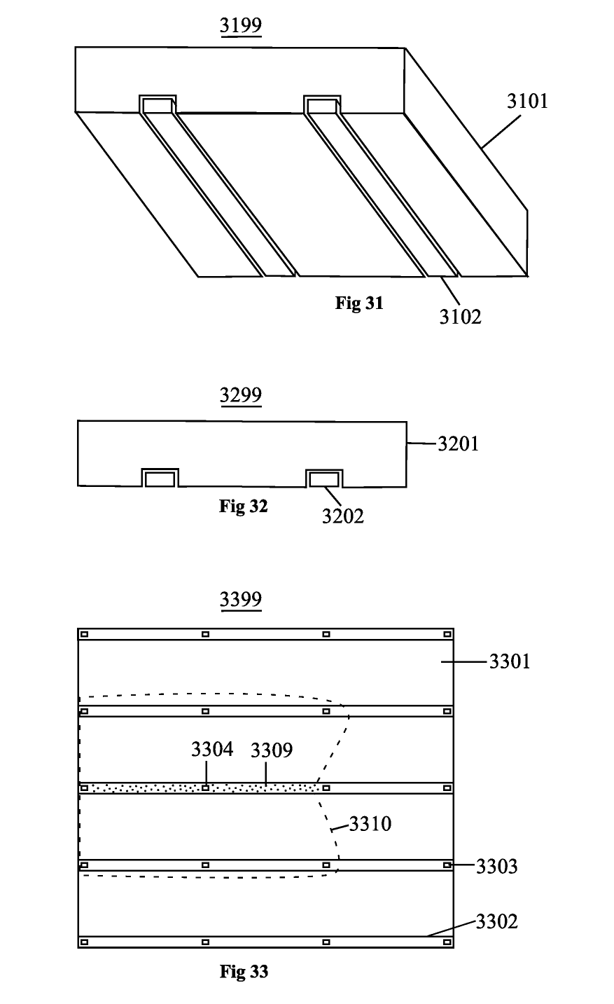

FIG. 31 illustrates a light source system 3199 according to an embodiment. A sheet light guide 3101 has embedded within it, linear light sources 3102. The linear light sources 3102 may be any known linear light sources, or they maybe created using point light sources emitting light into light guides having light deflecting particles, as disclosed in the present invention. The point light sources may be present at the ends or maybe embedded within the linear light sources. The sheet light guide 3101 has light deflecting particles, so that light emitted from the linear light sources 3102 traveling within the sheet light guide 3101 is deflected out of the sheet light guide 3101.

In an embodiment, the concentration of light deflecting particles in the linear light sources 3102 may be kept sparse, so that they are transparent to external light. Thus, if light traveling within the sheet light guide enters the linear light source, it will again enter the sheet light guide.

FIG. 32 illustrates the side view of a light source system 3299, according to an embodiment. Linear light sources 3202 are embedded within sheet light guide 3201 that has light deflecting particles. The embodiments disclosed in the present patent apply to sheet light guides having linear light sources as well as to linear light guides having point light sources.

FIG. 33 illustrates the bottom view of a light source system 3399, according to an embodiment. A sheet light guide 3301 having light deflector particles has embedded within it linear light sources 3302. The linear light sources 3302 are linear light guides having embedded point light sources 3303, and light deflecting particles 3309. In this way a large surface may be uniformly (or preferentially) brightly lighted using point light sources in a thin apparatus, in an efficient manner.

In an embodiment, each linear light source, or each point light source in the light source system 3399 can be turned on, off or dimmed individually. Lighting up a particular point light source will not light up the surface uniformly, but it will light it up more in a certain area. For example, lighting the point light source 3304 will cause more light to be emitted from the area 3310, than from other places. When the light source system 3399 is used in a backlight for flat panel displays, this can be used to selectively brighten or dim portions of the screen where bright or dark objects exist, thus giving better energy efficiency and better contrast. Each point light source may have separate emitters for separate colors, for example for red, green and blue colors, or alternately, some point light sources may have emitters of some colors and others may have emitters of other colors. In such cases, each emitter in a point light source may be brightened or dimmed individually so that not only the brightness, but also the color in a particular region can be controlled. When used as a backlight, the present invention will not only produce appropriate brightness, but also appropriate colors, to be further modified by the display panel to produce accurate color, giving more color vividness and more efficiency.

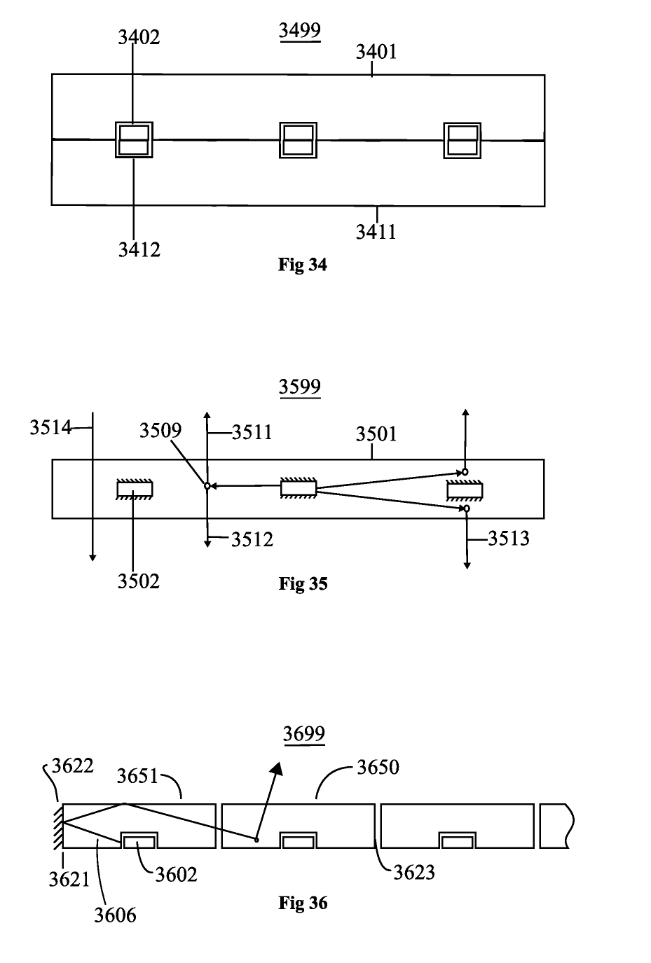

FIG. 34 illustrates a light source system 3499, according to one embodiment. A light guide 3401 has embedded light sources 3402, and light deflecting particles. Another light guide 3411 also has embedded light source 3412, and light deflecting particles. These light guides are placed side by side, to give a brighter light source. The light guides may also be fused or optically coupled using optical adhesives, to create a single light guide.

FIG. 35 illustrates a light source system 3599, according to one embodiment. The light source system 3599 is a light guide 3501 having light deflecting particles 3509 and embedded light sources 3502. The embedded light sources may be disposed near one surface of the light guide 3501, or they may be embedded inside the bulk of the light guide 3501, as has been illustrated. Mirrors are disposed above and below the light sources 3502, to protect light generated in the embedded light sources 3502 from directly exiting the light guide 3501, and to protect light traveling in the light guide 3501 from entering the light sources 3502. Deflected light 3511, 3512 and 3513 is emitted towards both the directions of the light guide 3501. In an embodiment, a mirror is disposed on one side of the light guide 3501, so that light is emitted in only one direction. In an embodiment, the concentration of light deflecting particles is kept low enough so that external light 3514 travels through the light guide 3501 primarily without deflection.

FIG. 36 illustrates a modular light source system 3699, according to one embodiment. The light source system 3699 comprises many modules such as module 3650, placed end-to-end. A module such as module 3650 is a light source system as described in the present invention, having a light guide comprising light deflecting particles, and one or more embedded light sources. The wall 3621 of the module 3651 at the end of the light source system 3699, has a mirror 3622, so that light is not wasted. The walls between two modules, such as wall 3623, may or may not have mirrors. If mirrors are not provided, light will mix from one module to the next, which gives good light emission continuity. In an embodiment, partial mirrors are provided on the lower parts of the walls. An exemplary light ray 3606 is emitted by a light source 3602, hits the mirror 3622, is guided by the module 3651, then enters another module 3650, and is deflected by a light deflecting particle to be emitted by the light source system 3699. Any such number of modules may be put together to give a light source of a required size, thus simplifying the manufacturing of light sources of different sizes to manufacturing modules which can be combined. The modules may have mechanical structures which can be used to easily fit them into each other, such as press-fitting latches or notches, which can be on the inter-modular walls or in other places. The modules may be fused or glued together. In an embodiment, all modules have the same concentration variation profile, which has more concentration away from the embedded light source, except for possibly a high concentration directly above the embedded light source.

We claim:

1. An apparatus comprising a light guide and one or more light sources, wherein the one or more light sources are embedded within the body of the light guide.

2. The apparatus of claim 1, further comprising light deflectors.

3. The apparatus of claim 1, wherein light emitted from at least one light source is coupled into the light guide such that all or primarily all light from the at least one light source will get coupled into a direction that is guided along the light guide.

4. The apparatus of claim 1, wherein at least one light source embedded within the body of the light guide is embedded in a recess in the body of the light guide.

5. The apparatus of claim 4, wherein the recess in the body of the light guide has the same shape as the light source embedded in it.

6. The apparatus of claim 1, wherein at least one light source reflects light exiting the light guide towards it back into the light guide.

7. The apparatus of claim 2, wherein the light deflectors are present in a lower concentration in regions close to at least one light source.
